(19) United States
(12) Patent Application Publication
(10) Pub. No.: US 2025/0124060 A1
(43) Pub. Date: Apr. 17, 2025

(54) NATURAL LANGUAGE QUESTION ANSWERING WITH EMBEDDING VECTORS

(71) Applicant: Permanence AI Inc., New York, NY (US)

(72) Inventor: Joseph Ellsworth Hackman, New York, NY (US)

(21) Appl. No.: 18/380,505

(22) Filed: Oct. 16, 2023

(51) Int. Cl. G06F 16/332; G06F 16/33; G06F 40/30

(52) U.S. Cl. CPC G06F 16/3329; G06F 16/3347; G06F 40/30

(57) ABSTRACT

Applications of a language model are improved by creating a prompt that includes representations that improve the accuracy and reliability of the language model. The representations may be added to a prompt generated by a user. The representations are selected using embedding vectors of the representations and the user-generated prompt. Responses of the language model are selected by computing scores of the responses.

### BACKGROUND

Language models (LMs) have proven to be valuable due to their ability to process and comprehend natural language. Applications of LMs span from customer service chatbots to language translation tools, transforming how users retrieve information. However, the use of LMs poses many challenges that include hallucinations, inconsistencies across versions, and unreliable information.

### SUMMARY

In some aspects, the techniques described herein relate to a computer-implemented method, the method including: receiving a natural language question; determining that the natural language question relates to a first reference document; computing an embedding vector for the natural language question, wherein the embedding vector represents the natural language question in a vector space; selecting one or more question-and-answer pairs from a set of available question-and-answer pairs using the embedding vector; creating a prompt for a language model, the prompt including: a representation of the natural language question, a representation of the one or more question-and-answer pairs, and an expected output format, wherein the expected output format requests a quotation of the first reference document or a citation to the first reference document; submitting the prompt to the language model; receiving a plurality of responses from the language model, the plurality of responses including a first response; computing response scores for the plurality of responses, wherein the response scores include a first response score and the first response score reflects an accuracy of the first response in relation to the expected output format; selecting the first response using the response scores; and determining an answer to the natural language question using the first response.

In some aspects, the techniques described herein relate to a method, wherein computing the first response score includes determining a number or severity of hallucinations in the first response.

In some aspects, the techniques described herein relate to a method, wherein computing the first response score includes determining an inclusion of a quotation or a citation from the first reference document.

In some aspects, the techniques described herein relate to a method, wherein computing the first response score includes verifying content of the quotation in the first reference document.

In some aspects, the techniques described herein relate to a method, wherein selecting the first response includes creating a second prompt for a second language model, wherein the second prompt includes the representation of the natural language question and the first response.

In some aspects, the techniques described herein relate to a method, wherein the second prompt asks the second language model to determine a validity of the first response to the natural language question.

In some aspects, the techniques described herein relate to a method, wherein: the prompt includes at least a portion of a reference document or a link to the reference document; and selecting the first response includes creating a second prompt for a second language model, wherein the second prompt includes the representation of the natural language question and the first response.

In some aspects, the techniques described herein relate to a method, wherein: wherein the second prompt asks the second language model to verify that the first response is consistent with the reference document.

In some aspects, the techniques described herein relate to a method, further including: determining pair scores for the set of available question-and-answer pairs; and selecting the one or more question-and-answer pairs using the pair scores.

In some aspects, the techniques described herein relate to a method, wherein determining the pair scores includes at least one of: determining a similarity of a question-and-answer pair to the natural language question; determining a number of hallucinations generated by the language model when a question-and-answer pair was used in a previous prompt; determining a number of citations generated by the language model when a question-and-answer pair was used in a previous prompt; or determining a number of times a question-and-answer pair was used in a previous prompt.

In some aspects, the techniques described herein relate to a system, including: at least one server computer including at least one processor and at least one memory, the at least one server computer configured to: receive a natural language question; determine that the natural language question relates to a first reference document; compute an embedding vector for the natural language question, wherein the embedding vector represents the natural language question in a vector space; select one or more question-and-answer pairs from a set of available question-and-answer pairs using the embedding vector; create a prompt for a language model, the prompt including: a representation of the natural language question, a representation of the one or more question-and-answer pairs, and an expected output format, wherein the expected output format requests a quotation of the first reference document or a citation to the first reference document; submit the prompt to the language model; receive a plurality of responses from the language model, the plurality of responses including a first response; compute response scores for the plurality of responses, wherein the response scores include a first response score and the first response score reflects an accuracy of the first response in relation to the expected output format; select the first response using the response scores; and determine an answer to the natural language question using the first response.

In some aspects, the techniques described herein relate to a system, wherein the at least one server computer is further configured to create the prompt for the language model by including the representation of the natural language question and the representation of the one or more question-and-answer pairs as a dialogue history with the language model.

In some aspects, the techniques described herein relate to a system, wherein the at least one server computer is further configured to: submit a second prompt to a second language model; receive a second plurality of responses from the second language model; compute second response scores for the second plurality of responses; and select the first response from the plurality of responses and the second plurality of responses.

In some aspects, the techniques described herein relate to a system, wherein the at least one server computer is further configured to: create a second prompt for the language model; receive a second plurality of responses from the language model using the second prompt; compute second response scores for the second plurality of responses; and select the first response from the plurality of responses and the second plurality of responses.

In some aspects, the techniques described herein relate to a system, wherein the at least one server computer is further configured to present, at a user interface, the answer to the natural language question.

In some aspects, the techniques described herein relate to a system, wherein computing the response scores includes obtaining a plurality of response embedding vectors for the plurality of responses.

In some aspects, the techniques described herein relate to a system, wherein obtaining the plurality of response embedding vectors includes querying a third-party service.

In some aspects, the techniques described herein relate to one or more non-transitory, computer-readable media including computer-executable instructions that, when executed, cause at least one processor to perform actions including: receiving a natural language question; determining that the natural language question relates to a first reference document; computing an embedding vector for the natural language question, wherein the embedding vector represents the natural language question in a vector space; selecting one or more question-and-answer pairs from a set of available question-and-answer pairs using the embedding vector; creating a prompt for a language model, the prompt including: a representation of the natural language question, a representation of the one or more question-and-answer pairs, and an expected output format, wherein the expected output format requests a quotation of the first reference document or a citation to the first reference document; submitting the prompt to the language model; receiving a plurality of responses from the language model, the plurality of responses including a first response; computing response scores for the plurality of responses, wherein the response scores include a first response score and the first response score reflects an accuracy of the first response in relation to the expected output format; selecting the first response using the response scores; and determining an answer to the natural language question using the first response.

In some aspects, the techniques described herein relate to one or more non-transitory, computer-readable media, wherein the prompt includes at least a portion of the first reference document or a link to the first reference document.

In some aspects, the techniques described herein relate to one or more non-transitory, computer-readable media, wherein at least one of the one or more question-and-answer pairs relates to a second reference document.

In some aspects, the techniques described herein relate to one or more non-transitory, computer-readable media, wherein determining the answer includes removing a quotation or a citation from the first response.

In some aspects, the techniques described herein relate to one or more non-transitory, computer-readable media, wherein the actions further include causing the language model to regenerate a response when the response scores are below a threshold value.

### BRIEF DESCRIPTION OF THE FIGURES

The invention and the following detailed description of certain embodiments thereof may be understood by reference to the following figures:

FIG. 1 shows aspects of an example system for answering questions with a language model.

FIG. 2 is a flowchart for data execution for an example system.

FIG. 3A shows aspects of an example language model prompt.

FIG. 3B shows aspects of a prompt generator.

FIG. 4 shows aspects of generating responses.

FIG. 5 shows aspects of response verification and scoring.

FIG. 6 is a flowchart of an example method for improving the accuracy of a language model.

FIG. 7 is a flowchart of another example method for improving the accuracy of a language model.

### DETAILED DESCRIPTION

Language models (LMs) offer solutions in content creation, aiding in research, facilitating voice assistants, and even contributing to creative fields. The advantage of these models lies in their ability to interpret context, nuance, and intent, making digital interactions more human-like and personalized.

However, integration and use of LMs pose several challenges. One notable issue is the phenomenon of “hallucinations,” where the model sometimes produces information that might sound plausible but is not rooted in factual accuracy. This behavior can lead to misinformation, making it necessary for users to cross-check and verify the information generated by the model, especially in critical applications.

Another challenge surfaces when considering the evolution of LMs. As these models undergo improvements and updates, inconsistencies can emerge across different versions. An input that produces a particular response in one version might yield a different, or at times, contrasting output in another. This variability can pose challenges for applications that depend on consistency and reliability.

The techniques described herein improve the consistency and accuracy of outputs generated by LMs. The techniques described herein reduce output hallucinations and improve output consistency and accuracy. In one example, the techniques described herein can be used to improve the accuracy and reliability of LMs in a question-and-answer dialogue application. In one application, an LM may be prompted with questions from a user regarding one or more documents. The techniques described herein may be used to improve the accuracy of the answers generated by the LM by processing the question prompt from the user and modifying the prompt. In some implementations, the techniques described herein may further intercept the answers generated by the LM and process the outputs to select the best answer and/or to adjust the prompt to the LM based on the analysis of the output.

The techniques described herein provide an improvement to the operations of a computer and an LM system by improving the quality and accuracy of answers generated by an LM. The techniques described herein reduce the cost associated with monitoring and maintaining an LM system. In many cases, to provide sufficient accuracy, LM-based systems require costly human supervision to detect hallucinations.

The techniques described herein improve the flexibility of an LM system and reduce the time and cost required to reconfigure or adjust a system to a different version of a language model. In traditional approaches, a change in an LM version may require time-consuming validation of the operation of an application with the changed LM. The techniques described herein enable automated and, in many cases, real-time validation of the LM behavior for an application. In many cases, the techniques described herein allow the system to self-adjust to changes in the behavior of an LM that may occur due to a version change of the LM.

The techniques described herein can be applied to any type of LM-based application. The examples described herein may include descriptions of a question-and-answer application, but the techniques described herein are not limited to these examples. The techniques described herein can be applied to various types of applications, such as customer service applications, search applications, and the like. The techniques described herein may be used in any application where a prompt is generated for a language model. A prompt for an LM is an input string or sequence of text provided to the model to elicit an output or response. A prompt serves as a cue for the language model to generate subsequent content or answer a question based on its training.

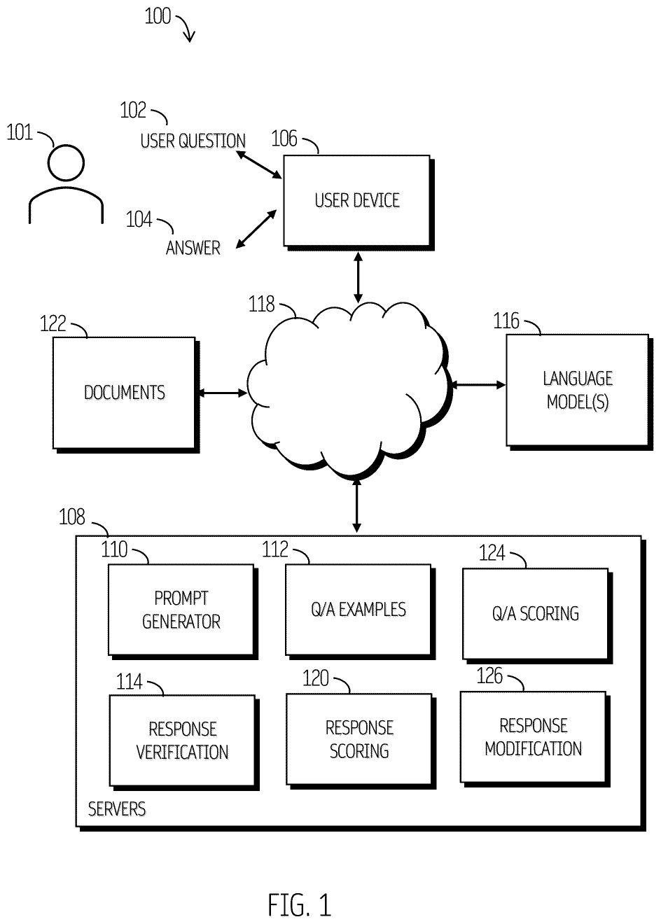

FIG. 1 shows aspects of an example system 100 that uses techniques described herein. In one example, the system 100 may be configured for an interactive question-and-answer application. The question-and-answer application may involve receiving question(s) from a user. The question may be in a natural language format and may be part of a conversation. The question may be related to the content of one or more documents, files, databases, and/or other enterprise data. In one example, the question may be related to a terms and conditions document, a loan document, a legal document, a technical document, and the like. An LM may be used to interpret the question and the document and generate an answer to the question.

In FIG. 1, user 101 generates a question 102 from user device 106, which may be referred to as a user question. User device 106 may be any appropriate computing device, such as a computer, tablet, or phone. User device 106 may be running any appropriate software to allow user 101 to submit a question 102 via user device 106. The user device 106 may submit question 102, either directly or indirectly, to a mathematical model such as a trained language model 116. The trained language model 116 may be trained to generate an answer 104 that is presented on the user device 106 in response to question 102. In some applications, question 102 may be directed to the content of one or more documents 122.

In some implementations, the user may directly interact with the LM such that question 102 may be directly provided as a prompt to the LM and the LM may generate an output that may be directly used as an answer 104. However, implementations with direct interaction with the LM may be subject to the drawbacks outlined herein related to inaccurate answers, hallucinations, and/or difficulties with LM version changes.

In some implementations, the system may include one or more components on one or more servers 108 configured to create a prompt for the language model. The server 108 may receive question 102 from the user and generate a prompt using a prompt generator 110. The prompt generator 110 may generate a prompt using question-and-answer examples 112 that may be subject to question-and-answer scoring 124. The prompt generator 110 may further generate a prompt using elements of documents 122 and question 102.

In some implementations, the system may include one or more components on one or more servers 108 configured to analyze the output of the model. The server may receive the outputs of the trained language model 116 that were generated in response to a prompt and perform one or more of response verification 114, response scoring 120, and/or response modification 126. The response from trained language model 116 may be evaluated and/or modified before it is provided as an answer 104 to user 101.

In some implementations, user device 106 may process question 102 using installed software in a standalone manner such that no other devices are assisting in the processing of question 102 (e.g., elements 110, 112, 114, 120, 124, 126 may be part of the user device 106). In some implementations, user device 106 may use a service provided over a network connection. For example, user device 106 may use network 118 to access one or more servers 108 that can execute a trained language model 116 to process the question 102 and return the answers to the user device 106. In some implementations, trained language model 116 may be implemented by one or more servers 108 and may not be a separate service.

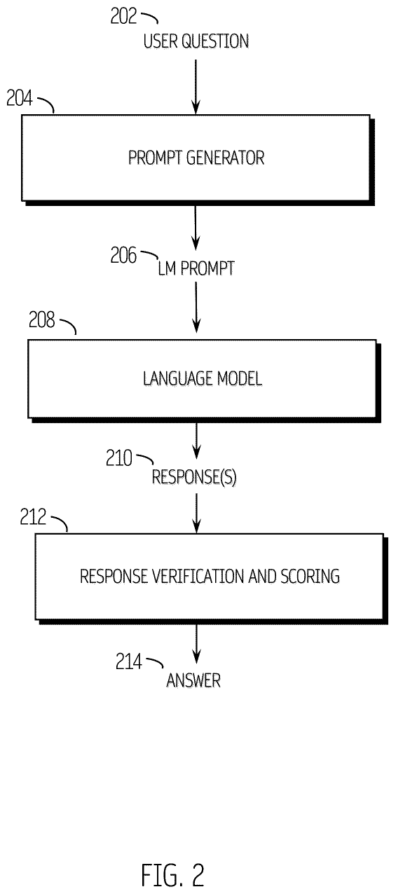

FIG. 2 is a flowchart for data execution for an example system. As a first step, a natural language question or user question 202 is generated by a user. The natural language question may be part of a conversation. A natural language question may be a text string that is typed or entered by a user. In some implementations, questions may be received via speech input and converted to text using automatic speech recognition. Questions may be captured by a microphone or from a file from a user device. In some implementations, user question 202 may include code snippets, numbers, and the like.

In one example, a question may relate to one or documents or other data sources. The question may include an explicit reference to a document, such as a filename or name of the document. In some cases, the question may include an implicit reference to a document that may be determined based on a conversation history, the location of the user, the source of the question, and the like. In some cases, the question may not include an implicit reference to a document, but a document may be inferred from the subject matter of the question. In one example, the question may relate to the terms and conditions of a service agreement, such as a credit card service agreement. A question may originate from a user who may be a customer of a credit card company, and the user may inquire about aspects that are defined in the terms and conditions document. The question may not explicitly include the name of the terms and conditions document but the relation to the document may be derived from the topic of the question and the context that the question may be directed to customer service of the credit card company.

Questions from users regarding a particular subject can come in various forms. The nuances in language, personal experiences, cultural backgrounds, and individual preferences can all affect how a question is framed. For example, while one person might ask, “When is my bill due?”, another might inquire, “Do I need to pay now?” or “How long do I have after I receive my bill?” These variations in questions may cause an LM to generate inconsistent or unreliable answers. The system may process the question prior to submitting the question to an LM. The question may be processed by a prompt generator 204. The prompt generator may be configured to generate a LM prompt 206. The LM prompt 206 may be structured to improve the accuracy and consistency of the output of a language model when presented with various forms of questions.

After the LM prompt 206 is generated, the LM prompt 206 may be processed by a language model 208. In some implementations, questions may be processed by the language model immediately or in real time after receiving them. In some implementations, processing with the language model may be executed in a batch mode or according to a schedule. The language model 208 may be any language model and may include large language models such as GPT, BARD, LLAMA, and the like.

Processing of the LM prompt 206 with the language model 208 may generate a response 210. The response may be natural language text that answers user question 202. In some implementations, response 210 may be evaluated with response verification and scoring 212 to determine the accuracy of the response, suitability of the response, formatting of the response, and the like. A response 210 that passes the response verification and scoring 212 may be provided to the user as the answer 214 to user question 202. A response 210 that fails the response verification and scoring 212 may be processed in different ways. In some implementations, a response that failed verification and scoring 212 may be provided as an answer with a notification (e.g., an indication that the answer may not be accurate). In some implementations, when a response fails verification and scoring 212, the system may cause the language model 208 to regenerate the response. In some cases, when a response fails verification and scoring 212, the system may generate a different LM prompt 206 and generate a different response 210 using the language model 208. In some implementations, the language model may generate multiple responses 210 for one LM prompt 206 (e.g., three or more responses). The multiple responses may be verified and scored, and the highest-scoring response may be selected as the answer 214.

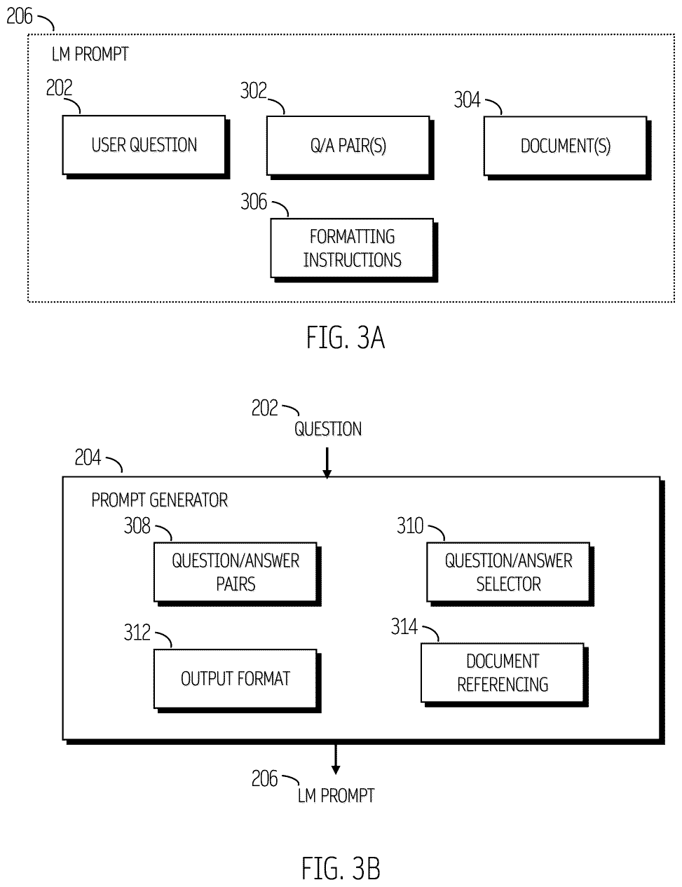

FIG. 3A shows aspects of one example LM prompt 206, that may be generated by a prompt generator 204. The LM prompt 206 may include other elements that are added to user question 202. In one example, the LM prompt 206 may include user question 202 and additional elements, such as ancillary text. As used herein, ancillary text may include any text that is included in a prompt and that may provide the LM with additional information to assist the language model in providing a response to the prompt. The ancillary text may be application-specific and may depend on the type of user input expected for a user, the type of output expected, and the like. In the example, where the user input is a question, the ancillary text may include a representation of one or more question and answer pairs 302. The representation of the question-and-answer pairs 302 may include pairs that are similar to user question 202. In some implementations, the representations of the question-and-answer pairs 302 may include negative samples or examples that include incorrect or bad responses to questions.

In some implementations where the question relates to external data such as documents, the LM prompt 206 may include a representation of relevant documents 304. The representation of the relevant documents 304 may include the text of the document, excerpts from the document, a link to the document, and the like. The LM prompt 206 may further include response formatting instructions 306. The response formatting instructions 306 may include language or other instructions that indicate desired or required characteristics of the response. For example, the formatting instructions may include instructions to include citations to or quotations from document 304 that are relevant to user question 202. In another example, formatting instructions may include instructions about the length of the response, tone, and the like.

The elements of the LM prompt 206 (e.g., elements 202, 302, 304, 306) may be concatenated into one or more strings. In some implementations, separators or special tokens or sets of characters may be used to separate or identify the different elements of the LM prompt 206.

FIG. 3B shows aspects of a prompt generator 204 that may be used to generate the LM prompt 206. The prompt generator 204 may receive a user question 202 and generate an LM prompt 206. The prompt generator 204 may be configured to include samples of responses that were identified as accurate or acceptable answers. The prompt generator 204 may include access to a database or other storage of samples. In the example of a question-and-answer system, the prompt generator may include a database of question-and-answer pairs 308. The question-and-answer pairs 308 may include samples that were identified (by a person and/or other model) as having desired properties and/or accurate answers to the questions. The prompt generator 204 may include a question-and-answer selector 310 to select one or more of the question-and-answer pairs 308 for inclusion in the prompt.

The question-and-answer selector 310 may include various methods for selecting the sample and the selection method may depend on system settings, application, available computation resources, and the like. The question-and-answer selector 310 may select question-and-answer pairs using any combination of the following techniques.

In one example, the question-and-answer selector 310 may select from question-and-answer pairs 308 randomly. In another example, the question-and-answer selector 310 may select from the question-and-answer pairs 308 based on a similarity measure.

In some implementations, a similarity measure may be determined using semantic representations. Any appropriate semantic representation may be used, such as an embedding that represents text (e.g., a question or a question-and-answer sample) in a vector space in a manner that preserves information about the meaning of the text. For example, where two different text items represent similar information, the corresponding vector space embeddings may be close to each other in the vector space. For another example, where two different text items represent very different information, the corresponding vector space embeddings may be far from each other in the vector space. Any appropriate vector space embeddings may be used. For example, a vector space embedding may be computed by processing text with a neural network (e.g., a BERT neural network).

In embodiments, embeddings may be used to represent whole sentences. In one example, an embedding may represent a user question, a question-and-answer pair, the question of a question-and-answer pair, the answer of a question-and-answer pair, a response, an LM prompt, or any combination thereof. In some implementations, embeddings may be obtained using an external third-party service (e.g., OpenAI, Pinecone, Elasticsearch, semantic search-based methods, etc.).

In some implementations, an embedding of user question 202 and embeddings of the question-and-answer pairs 308 (or embeddings of the question or answer of the question-and-answer pairs 308) may be used to select question-and-answer pairs. User question 202 and the question-and-answer pairs 308 may be represented as a vector in a vector space. The vector representations of the question-and-answer pairs 308 may then be processed to select one or more pairs that are closest (e.g., using a cosine similarity measure) to the vector representation of user question 202. In some implementations, pairs of questions and answers may be selected such that they relate to the same document as the question from the user.

In some implementations, the distance may be between the embedding of a user question and any of an embedding of the question-and-answer pair sample, an embedding of a question of the question-and-answer sample, or an embedding of the answer of the question-and-answer sample.

In some implementations, vector representations of the question-and-answer pairs 308 may then be processed to select one or more pairs that provide a sampling of different varieties of pairs. In some cases, selecting pairs that are closest may return variations (e.g., small variations in the wording of a question-and-answer pair). In some implementations, coverage of a greater variety of pairs may be selected by selecting pairs that are at a greater distance in the vector space. In one example, N pairs may be selected randomly from the top 100*N closest pairs in the vector space. In another example, a neural network may be trained to select embeddings (based on a neural network similarity metric) for pairs that may provide the desired variety of pairs.

In some implementations, the question-and-answer selector 310 may select from question-and-answer pairs 308 by computing pair scores for question-and-answer pairs. Pair scores may be computed using any of the techniques described herein, and a pair score may indicate the suitability of a question-and-answer pair for a user question. Question-and-answer selector 310 may use a ranking of the question-and-answer pairs 308, such as ranking according to the pair scores. The question-and-answer pairs 308 may be ranked or scored according to the number of times or the ratio of times each question-and-answer sample was included in an LM prompt that resulted in a response from an LM that passed validation and verification.

The prompt generator 204 may further include an element for document referencing 314. As described herein, in some applications, user question 202 may be in relation to one or more data sources, such as documents. User question 202 may include an explicit reference to a document, and the element for document referencing 314 may identify the explicit reference in the question and include the document, link to the document, or other text references that allow the language model to access the referenced document. In some cases, the element for document referencing 314 may identify implicit document references from previous conversation history (when available), the origin location of the user generating the question, the application, the client domain, and the like. In some cases, the question may not include an implicit reference to a document, but a document may be inferred from the subject matter of the question through any appropriate techniques, such as topic modeling or natural language intents.

The prompt generator 204 may further include an element for generating a specification for the output format 312. Output format 312 may include aspects such as the length of the response, formatting, requirement for inclusion of quotations from a referenced document, and the like. Output format 312 may be selected based on a user configuration for an application, ranking of the requirements with respect to the number of responses that resulted in successful verification, and the like. Output format 312 may be represented as a string, such as a list of requirements or a sentence that lists the requirements.

In one example, in one question-and-answer application, a user may ask the following question “How strictly will a spending limit be enforced on my additional card holder?” The prompt generator 204 may receive the question and generate an LM prompt 206. The document referencing 314 element may identify that the question pertains to terms and conditions associated with a credit card account and may determine an appropriate <link> to the document. The output format 312 element may identify formatting and content requirements and may generate a string such as the following string: “When answering a question, cite the relevant text from the document word for word, inside double quotation marks.” The question-and-answer selector 310 may identify question-and-answer pairs 308 that should be included in the LM prompt as examples of responses to questions with the proper formatting and articulation of answers. In embodiments, the selected question-and-answer pairs 308 may relate to different documents and questions. The prompt generator 204 may assemble the outputs of the different elements into an LM prompt:

Question: How strictly will a spending limit be enforced on my additional cardholder? Requirements: Use the following document to answer questions. When answering a question, cite the relevant text from the document word for word, inside double quotation marks. <link>; Sample: Will adding my 4-year-old son to my card help him build credit? No, adding a 4-year-old as an Additional Card Member will not help them build credit. The document states that “Additional Card Members do not have accounts with us but they can use your Account subject to the terms of the Card Member Agreement.”

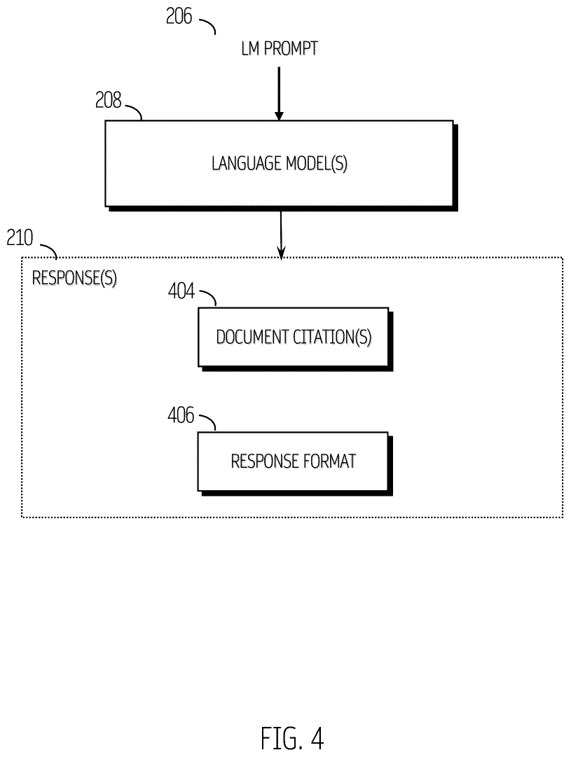

FIG. 4 shows aspects of generating responses 210 using the LM prompt 206. The LM prompt 206 may be provided to one or more language models 208. The language models may process the LM prompt and generate a response that, if accurate, will provide an answer to the question and include the format specified by the LM prompt 206. In one example, an accurate response 210 may include the required document quotations 404, and the proper response format 406 (e.g., length of response, tone of response). In embodiments, the language model 208 may generate a plurality of responses to the same LM prompt. In one example, the language model 208 may generate the following two responses for an LM prompt:
1. The document states: “If we agree to apply a limit, it is not a guarantee that the Additional Card Member will be able to make Purchases or cash access transactions up to the applicable limit. [. . . ] we may, but are not required.”
2. The document states that “If we agree to apply a limit, it is not a guarantee that the Additional Card Member will be able to make Purchases or cash access transactions up to the applicable limit.”

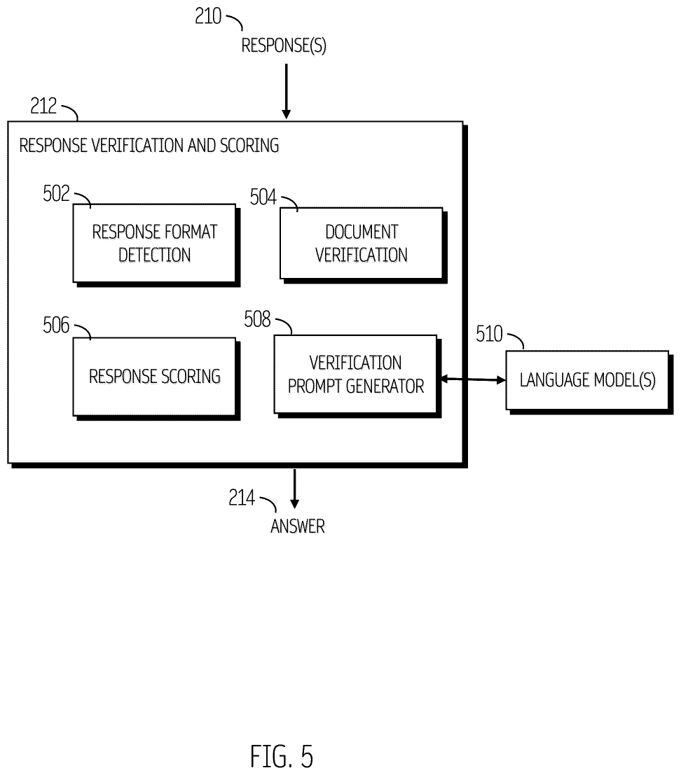

FIG. 5 shows aspects of response verification and scoring 212. In embodiments, multiple LM prompts 206 may be generated and submitted to one or more language models 208 to generate multiple responses 210. In some implementations, one LM prompt 206 may be submitted to multiple language models 208 to generate multiple responses 210. The response(s) 210 may be processed to determine if the response is accurate with respect to the question and/or the requirements indicated in the LM prompt. In some implementations, all responses (regardless of the LM prompt or language model 208 used to generate each response) may be processed using the same functions, rules, and modules. In some implementations, different functions, rules, and modules may be used to process responses that correspond to different LM prompts or language models.

In some implementations, response verification and scoring 212 may include response format detection 502. Response format detection 502 may identify if the response includes the output format 312 identified in the LM prompt 206. Response format detection 502 may include detection of required quotations, length of response, and the like. In some implementations, the response format detection 502 may output a score value based on the number or percentage of the requirements being present in the response. Any appropriate methods may be used for response format detection 502 and may include the use of a trained model, rule-based search methods, string parsing routines, and the like.

In some implementations, response 210 may be processed to perform document verification 504. In one example, document verification 504 may include a process for determining if quotations included in the response correspond to actual elements of a reference document(s) 122. In some implementations, document verification 504 may output a positive result only if the quote in the response exactly matches the text of the reference document. In some implementations, document verification 504 may output a positive result if the quote in the response is similar to the text of the document. In some implementations, document verification 504 may output a score (such as a value between and including 0 and 1) that reflects the similarity of the quoted text to the actual text of the reference document. Document verification 504 may include a search of the quoted text of the response in the reference document. Any appropriate methods may be used for document verification 504 and may include the use of a trained model, rule-based search methods, string parsing routines, and the like.

In some implementations, response 210 may be processed to determine if response 210 is consistent with question 102 provided by the user. Verification of the response may include querying another language model 510 to evaluate if the response is consistent or appropriate for the question. In one implementation, verification may include a verification prompt generator 508. The verification prompt generator 508 may generate a prompt for language model(s) 510. The prompt may include a representation of the response 210, a representation of the question 102, and an instruction for language model 510 to evaluate if response 210 is correct for the question 102. The language model 510 may return a score in response to the prompt that reflects if the response is consistent with the question based on the language and/or semantics of the question and response.

In some implementations, response and verification and scoring 212 may include response scoring 506 to generate an overall response score. The overall response score may be a function of response scores generated from response format detection 502, document verification 504, and/or verification from language models 510. The response scoring 506 may generate a response score (e.g., a number between 0 and 1) which may be used to determine if the response should be provided as an answer 214 in response to question 102. Response 210 may be accepted as an answer based on a threshold value of the score (e.g., a response score above a threshold value may indicate acceptance of the response). When multiple responses are generated and scored, the highest-scoring response above a threshold may be selected as the answer 214. In some cases, when all of the responses are below a threshold value, the language model may be instructed to regenerate a new set of responses.

In embodiments, response scoring 506 may include scoring based on embeddings of response 210 and user question 202. Scoring may include determining embedding vectors of the responses 210, an embedding vector of the user question 202, and computing a similarity or distance between the embedding vector of the question and the embedding vectors of the responses. A response corresponding to an embedding vector that is closest to the embedding vector of the question may be selected as the answer.

In some implementations, response scoring 506 may include tracking of characteristics of an LM prompt 206. Statistics for LM prompt elements (e.g., question and answer pairs 302, response formatting instructions 306) may be tracked according to how many times each LM prompt element resulted in a selected answer, how many responses scored higher than a threshold score, and the like.

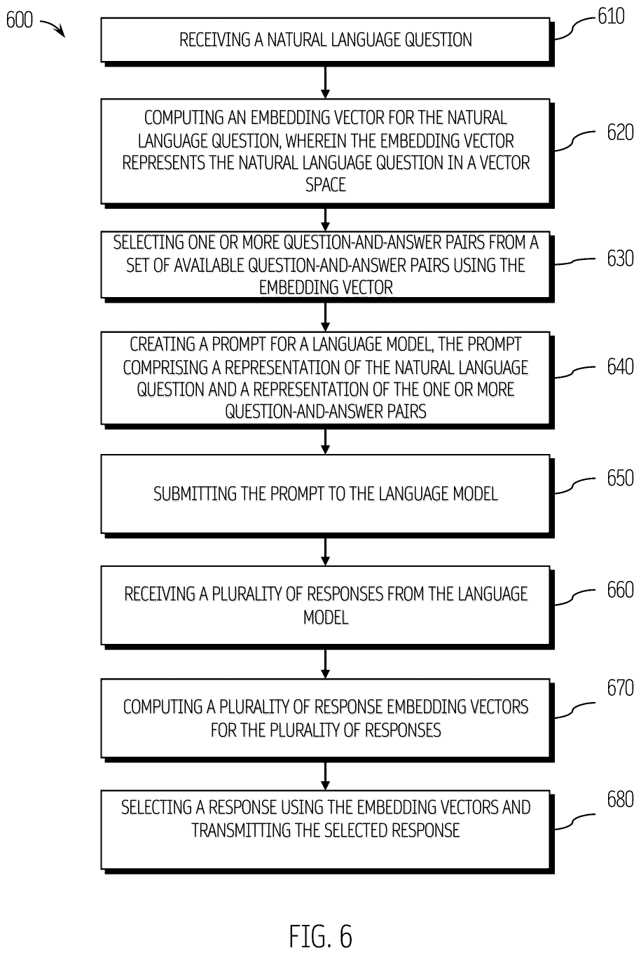

FIG. 6 is a flowchart of an example method 600 for improving the accuracy of a language model. In one example, method 600 may be implemented by the systems and structures described with respect to FIGS. 2-5. At step 610, a natural language question or user question may be received. The question may be received from a user as a single question or in the context of a conversation. At step 620, an embedding vector for the natural language question may be computed. The embedding vector represents the natural language question in a vector space. Any appropriate method and model may be used to compute the embedding vector and may include BERT, Doc2Vec, GPT, and the like. In some implementations, an embedding vector may not be used, and step 620 may not be performed.

At step 630, one or more question-and-answer pairs may be selected from a set of available question-and-answer pairs. In some implementations, the question-and-answer pairs are selected using the embedding vector. The set of available question-and-answer pairs may be a set of question-and-answer pairs that were captured from previous interactions with a question-and-answer application. In some implementations, the set of question-and-answer pairs may include only pairs that accurately answer the questions. In some implementations, the selection of the questions-and-answer pairs may include computing an embedding vector for each pair (or the question or answer of a pair) and computing a similarity between the embedding vectors of the question-and-answer pairs and the embedding vector of the question. Any appropriate method can be used to determine similarity and may include cosine similarity, Euclidean distance, and the like.

In some implementations, the question-and-answer pairs may be selected from the set of available question-and-answer pairs using pair scores. Pair scores may be computed using any appropriate techniques, such as based on measures of success of the pairs generating an accurate answer when used in an LM prompt. In one example, the pairs may be selected based on a number of hallucinations generated by the language model when a question-and-answer pair was used in a previous prompt. In another example, the pairs may be selected based on a number of citations generated by the language model when a question-and-answer pair was used in a previous prompt and/or based on a number of times a question-and-answer pair was used in a previous prompt.

At step 640, a prompt for a language model may be created. The prompt may include a representation of the user question and a representation of the one or more question-and-answer pairs. Representation of the user question and the question-and-answer pair may include the text or modified text of the user question and the question-and-answer pairs. In some implementations, the representation of the question-and-answer pairs may include a representation as a dialogue history. The representations may include the pairs specified as previous interactions with a language model or as the context for conversations with a language model.

In some applications, the user question may relate to one or more reference documents and the prompt may be created to include a representation of the reference document.

In one example, the representation of the document may include text of the document, partial text of the document, a link to the document, and the like.

In some applications, the prompt may include expected output formatting of a response. Expected output formatting may include instructions that specify that a response should include specific length, document quotations (e.g., include double quotations, not include segue before or after quoted text), tone, capitalizations (e.g., capitalize proper nouns), and the like. In some implementations, the expected output formatting may include instructions to obfuscate sensitive information that may be generated in the answer (e.g., phone numbers, credit limits, social security numbers, phone numbers, etc.). Obfuscation may include generating placeholder tokens in place of sensitive information.

The expected output formatting may be a natural language string that describes or lists the elements of the expected output formatting. In some implementations, the prompt may include examples of the expected output formatting. The prompt may include an example (e.g., a sentence) that includes the desired quotations, capitalizations, tone, length, and the like. The example may include sample question and answer pair(s) that meet the expected output formatting. In some implementations, the example of the expected output may include a label that identifies it as a formatting example. In one example, the sample may be prefaced with a phrase such as “Format the output as in the following example:”.

In embodiments, the expected output formatting may be provided to the LM model as a type of one-shot learning input. One-shot learning refers to a type of machine learning where a model is trained to recognize patterns, categories, or objects based on very few examples, such as just one example. A prompt with an example of desired expected output formatting may be a training example for the LM model that is provided with the LM prompt.

At step 650, the prompt may be submitted to the language model. The language model may be implemented by the same entity implementing method 600 or by a third-party entity. The prompt may be submitted via an API of the language model. At step 660, one or more responses from the language model may be received. The responses may be received via an API of the language model. The responses may be natural language responses that provide answers to the user question.

At step 670, one or more response embedding vectors for the one or more responses may be computed. The embedding vectors may be computed using any appropriate method and may include any methods described herein. In some implementations, embedding vectors may not be computed and step 670 may not be performed.

At step 680, a response may be selected.

In some implementations, the response may be selected by comparing the embedding vectors of the responses with the embedding vector of the user question. Any appropriate method may be used to compare the embedding vectors.

In some implementations, the responses may be scored and selected based on their scores. Response scores may be computed by determining the number and/or severity of hallucinations in the responses. In one example, the number and/or severity of hallucinations may be determined by verifying that the quoted text in the responses can be found in the text of the document referenced in the prompt. If the quoted text does not exactly match the text of the referenced document, the response may be considered to include hallucinations. The severity of the hallucinations may be based on how different the quoted text is from the text of the reference document. The severity may be based on the number of words that are mismatched between the quotations and a portion of the referenced document.

In some implementations, the responses may be scored and selected based on the presence of the expected output formatting specified in the prompt. In one example, a score may include the number or percentage of the output formatting features that were specified that are present in the responses.

An answer to the user question may be determined from the selected response. In some implementations, the answer may be the same as the response. In some implementations, the answer may be a modified version of the response, such as by removing a quotation, citation, or other text from the response. In some implementations, the response may also be modified to remove text that segues or transitions into a quotation, such as “The terms document states the following.” The answer may then be transmitted to or presented to the user.

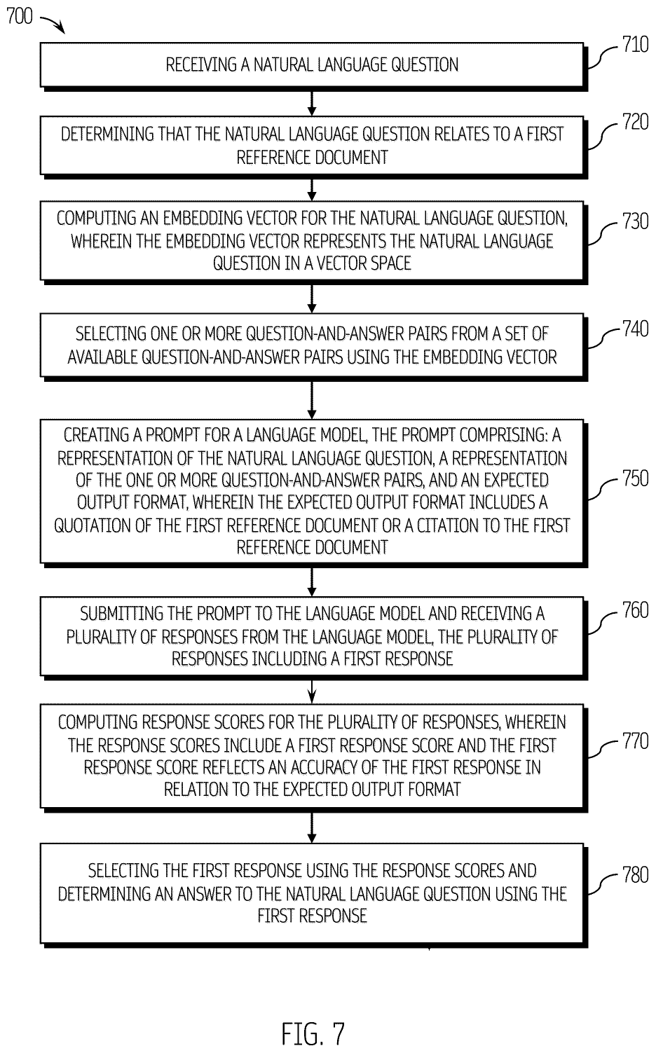

FIG. 7 is a flowchart of another example method 700 for improving the accuracy of a language model. In one example, method 700 may be implemented by the systems and structures described with respect to FIGS. 2-5. At step 710, a natural language question may be received. At step 720, the method may include determining that the natural language question relates to a first reference document. The reference document may be explicitly or implicitly referenced by the question or may be determined from the content of the question as described herein. At step 730, an embedding vector for the natural language question may be computed. Any appropriate method and model may be used to compute the embedding vector as described herein. In some implementations, an embedding vector may not be used, and step 730 may not be performed.

At step 740, one or more question-and-answer pairs may be selected from a set of available question-and-answer pairs. In some implementations, the question-and-answer pairs are selected using the embedding vector. In some implementations, the question-and-answer pairs as selected using pair scores.

At step 750, a prompt for a language model may be created. The prompt may include a representation of the natural language question, a representation of the one or more question-and-answer pairs, and an expected output format. The expected output may include a request or requirement for at least one of a quotation from or a citation to the first reference document. In implementations, as described herein, the expected output format may include one or more natural language instructions, examples, and the like. In one example, the expected output may include a statement (which may include an example of the expected output) that the response should include a quotation from or a citation to the relevant portion of the reference document. The quotation may be expected to be a direct quotation or a rephrasing/summary of a portion of the referenced document that is relevant to or supports the response or question. The citation may be expected to be a reference (e.g., a paragraph number, page number, line numbers) to portions of the reference document that relate to or support the response or the question.

At step 760, the prompt may be submitted to the language model. The language model may be implemented by the same entity implementing method 700 or by a third-party entity. The prompt may be submitted via an API of the language model. One or more responses from the language model may be received. The responses may be received via an API of the language model. The responses may be natural language responses that provide answers to the user question.

At step 770, the method may include computing response scores for the plurality of responses. In some implementations, the response scores may reflect the accuracy of the plurality of responses in relation to the expected output format. A response score may include the number or percentage of the output formatting features that were specified that are present in the responses. In one example, the response score may a function of the presence of the quotation or citation as indicated by the expected output format.

Response scores may be computed by determining the number and/or severity of hallucinations in the responses. In one example, the number and/or severity of hallucinations may be determined by verifying that the quoted text in the responses can be found in the text of the document referenced in the prompt. If the quoted text does not exactly match the text of the referenced document, the response may be considered to include hallucinations. The severity of the hallucinations may be based on how different the quoted text is from the text of the reference document. The severity may be based on the number of words that are mismatched between the quotations and a portion of the referenced document.

In some implementations, response scores may be computed using response embeddings as described herein.

At step 780, a response may be selected using the response scores. An answer may be determined from the response, and the answer may be presented or transmitted to a user as the answer to the question. The answer may be provided to a user via a user interface at a user's device.

The methods and systems described herein may be deployed in part or in whole through a machine that executes computer software, program codes, and/or instructions on a processor. “Processor” as used herein is meant to include at least one processor and unless context clearly indicates otherwise, the plural and the singular should be understood to be interchangeable. Any aspects of the present disclosure may be implemented as a computer-implemented method on the machine, as a system or apparatus as part of or in relation to the machine, or as a computer program product embodied in a computer readable medium executing on one or more of the machines. The processor may be part of a server, server computer, client, network infrastructure, mobile computing platform, stationary computing platform, or other computing platform. A processor may be any kind of computational or processing device capable of executing program instructions, codes, binary instructions, and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client, and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of program across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other network types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable transitory and/or non-transitory computer-readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer-executable media having a processor capable of executing program instructions stored thereon as a monolithic software structure, as standalone software modules, or as modules that employ external routines, code, services, circuits, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams, or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application-specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to generate computer-executable instructions to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionalities may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference in their entirety.

What is claimed is:

1. A computer-implemented method, the method comprising:
receiving a natural language question;
determining that the natural language question relates to a first reference document;
computing an embedding vector for the natural language question, wherein the embedding vector represents the natural language question in a vector space;
selecting one or more question-and-answer pairs from a set of available question-and-answer pairs using the embedding vector;
creating a prompt for a language model, the prompt comprising:
a representation of the natural language question,
a representation of the one or more question-and-answer pairs, and
an expected output format, wherein the expected output format requests a quotation of the first reference document or a citation to the first reference document;
submitting the prompt to the language model;
receiving a plurality of responses from the language model, the plurality of responses including a first response;
computing response scores for the plurality of responses, wherein the response scores include a first response score and the first response score reflects an accuracy of the first response in relation to the expected output format;
selecting the first response using the response scores; and
determining an answer to the natural language question using the first response.

2. The method of claim 1, wherein computing the first response score comprises determining a number or severity of hallucinations in the first response.

3. The method of claim 1, wherein computing the first response score comprises determining an inclusion of a quotation or a citation from the first reference document.

4. The method of claim 3, wherein computing the first response score comprises verifying content of the quotation in the first reference document.

5. The method of claim 1, wherein selecting the first response comprises creating a second prompt for a second language model, wherein the second prompt includes the representation of the natural language question and the first response.

6. The method of claim 5, wherein the second prompt asks the second language model to determine a validity of the first response to the natural language question.

7. The method of claim 1, wherein:
the prompt comprises at least a portion of a reference document or a link to the reference document; and
selecting the first response comprises creating a second prompt for a second language model, wherein the second prompt includes the representation of the natural language question and the first response.

8. The method of claim 7, wherein:
wherein the second prompt asks the second language model to verify that the first response is consistent with the reference document.

9. The method of claim 1, further comprising:
determining pair scores for the set of available question-and-answer pairs; and
selecting the one or more question-and-answer pairs using the pair scores.

10. The method of claim 9, wherein determining the pair scores comprises at least one of:
determining a similarity of a question-and-answer pair to the natural language question;
determining a number of hallucinations generated by the language model when a question-and-answer pair was used in a previous prompt;
determining a number of citations generated by the language model when a question-and-answer pair was used in a previous prompt; or
determining a number of times a question-and-answer pair was used in a previous prompt.

11. A system, comprising:
at least one server computer comprising at least one processor and at least one memory, the at least one server computer configured to:
receive a natural language question;
determine that the natural language question relates to a first reference document;
compute an embedding vector for the natural language question, wherein the embedding vector represents the natural language question in a vector space;
select one or more question-and-answer pairs from a set of available question-and-answer pairs using the embedding vector;
create a prompt for a language model, the prompt comprising:
a representation of the natural language question,
a representation of the one or more question-and-answer pairs, and
an expected output format, wherein the expected output format requests a quotation of the first reference document or a citation to the first reference document;
submit the prompt to the language model;
receive a plurality of responses from the language model, the plurality of responses including a first response;
compute response scores for the plurality of responses, wherein the response scores include a first response score and the first response score reflects an accuracy of the first response in relation to the expected output format;
select the first response using the response scores; and
determine an answer to the natural language question using the first response.

12. The system of claim 11, wherein the at least one server computer is further configured to create the prompt for the language model by including the representation of the natural language question and the representation of the one or more question-and-answer pairs as a dialogue history with the language model.

13. The system of claim 11, wherein the at least one server computer is further configured to:
submit a second prompt to a second language model;
receive a second plurality of responses from the second language model;
compute second response scores for the second plurality of responses; and
select the first response from the plurality of responses and the second plurality of responses.

14. The system of claim 11, wherein the at least one server computer is further configured to:
create a second prompt for the language model;
receive a second plurality of responses from the language model using the second prompt;
compute second response scores for the second plurality of responses; and
select the first response from the plurality of responses and the second plurality of responses.

15. The system of claim 11, wherein the at least one server computer is further configured to present, at a user interface, the answer to the natural language question.

16. The system of claim 11, wherein computing the response scores comprises obtaining a plurality of response embedding vectors for the plurality of responses.

17. The system of claim 16, wherein obtaining the plurality of response embedding vectors comprises querying a third-party service.

18. One or more non-transitory, computer-readable media comprising computer-executable instructions that, when executed, cause at least one processor to perform actions comprising:
receiving a natural language question;
determining that the natural language question relates to a first reference document;
computing an embedding vector for the natural language question, wherein the embedding vector represents the natural language question in a vector space;
selecting one or more question-and-answer pairs from a set of available question-and-answer pairs using the embedding vector;
creating a prompt for a language model, the prompt comprising:
a representation of the natural language question,
a representation of the one or more question-and-answer pairs, and
an expected output format, wherein the expected output format requests a quotation of the first reference document or a citation to the first reference document;
submitting the prompt to the language model;
receiving a plurality of responses from the language model, the plurality of responses including a first response;
computing response scores for the plurality of responses, wherein the response scores include a first response score and the first response score reflects an accuracy of the first response in relation to the expected output format;
selecting the first response using the response scores; and
determining an answer to the natural language question using the first response.

19. The one or more non-transitory, computer-readable media of claim 18, wherein the prompt comprises at least a portion of the first reference document or a link to the first reference document.

20. The one or more non-transitory, computer-readable media of claim 19, wherein at least one of the one or more question-and-answer pairs relates to a second reference document.

21. The one or more non-transitory, computer-readable media of claim 18, wherein determining the answer comprises removing a quotation or a citation from the first response.

22. The one or more non-transitory, computer-readable media of claim 18, wherein the actions further comprise causing the language model to regenerate a response when the response scores are below a threshold value.
